(19) United States
(12) Patent Application Publication
(10) Pub. No.: US 2013/0215332 A1
(43) Pub. Date: Aug. 22, 2013

(54) IMAGE AND SOUND CONTROLLER

(71) Applicant: Denso Corporation, (US)

(72) Inventors: Arihiro MATSUMOTO, Nagoya-city (JP); Masakazu Itou, Kariya-city (JP); Toshihide Ando, Chita-gun (JP); Hiroshi Ishiguro, Anjo-city (JP)

(73) Assignee: Denso Corporation, Aichi-Pref (JP)

(21) Appl. No.: 13/767,248

(22) Filed: Feb. 14, 2013

(30) Foreign Application Priority Data
Feb. 17, 2012 (JP) 2012-32923

(51) Int. Cl. H04N 5/66

(52) U.S. Cl. CPC H04N 5/66
USPC 348/738

(57) ABSTRACT

An image and sound controller for a vehicle includes: an output control device for controlling image display devices and a sound output device on the vehicle. The output control device executes application programs simultaneously so that images and sounds are provided by the application programs, distributes the images to the image display devices so that each image display device displays at least one image, and controls the sound output device to output the sounds. The application programs include predetermined audio application programs, each of which provides a sound content. When the output control device executes the predetermined audio application programs simultaneously, the output control device controls the image display devices and the sound output device to output the images and sounds exclusively between the predetermined audio application programs.

### CROSS REFERENCE TO RELATED APPLICATION

This application is based on Japanese Patent Application No. 2012-32923 filed on Feb. 17, 2012, the disclosure of which is incorporated herein by reference.

### TECHNICAL FIELD

The present disclosure relates to an image and sound controller for controlling an image and a sound, which are output according to a program executed by an in-vehicle apparatus.

### BACKGROUND

Conventionally, an in-vehicle apparatus for outputting an image and a sound can execute various application programs for an audio-visual function and a navigation function. A technique for controlling the output image and the output sound according to the application programs is disclosed in JP-A-2007-145137.

In the above technique, when multiple output requests according to multiple programs arise, it is necessary to adjust an output condition, In order to control multiple output requests, a predetermined table is prepared. In view of contents of the display image and the output sound according to all of programs, the table defines a device, from which the image or the sound is output, a content to be output, and an outputting manner of the content. When multiple output requests arise according to multiple programs, based on the table, an output resources of the display image and the output sound are appropriately arranged, so that the output contents are controlled.

JP-A-2007-145137 teaches a method for combining the display images, which are generated by two application programs, on one display screen. However, if two or more display devices are mounted on a vehicle, JP-A-2007-145137 does not suggest a method for controlling multiple display images generated by the application programs on multiple display screens.

A method for executing multiple programs at the same time in an in-vehicle system having multiple display devices may be such that, for example, a front seat display device and a rear seat display device independently display different display images generated by different application programs. However, when the images generated by the application programs are independently assigned to multiple display screens, respectively, the following difficulties may arise.

For example, one display screen displays an image generated by an application program for a video picture including an image and a sound such as a program for functioning as a video player and a television, and another display screen displays an image generated by an application program for an audio such as a program for functioning as a music player and a radio. These application programs provide to output a sound for an user of the in-vehicle system. In this case, each display screen displays the image, and further, each display device outputs the sound simultaneously.

In the above case, regarding the display images by the application programs, each display image is independently displayed on a corresponding display screen, so that the user does not confuse the images, i.e., visual information of the images is not mixed. However, when a sound output system is commonly used for two display devices, sound sources by the programs may be crossed. In order to avoid the cross line, it is considered that each sound source is output from an individual sound output system. However, even when the sound output systems are assigned to the programs, respectively, the sound is output according to the programs in the same compartment of the vehicle. Thus, the user listens to the sound from multiple sound sources, which is mixed in a narrow compartment. When multiple sound sources output sound at the same time, it is difficult for the user to listen to the sound. Further, the mixed sound may bother the user.

### SUMMARY

It is an object of the present disclosure to provide an image and sound controller for controlling an image and a sound, which are output according to a program executed by an in-vehicle apparatus. The in-vehicle apparatus includes multiple display devices, and the controller controls the images and the sound appropriately, which are generated by multiple application programs.

According to an example aspect of the present disclosure, an image and sound controller for a vehicle includes: an output control device for controlling a plurality of image display devices and at least one sound output device, which are mounted on the vehicle. The output control device executes a plurality of application programs simultaneously so that a plurality of images and sounds are provided by the plurality of application programs. The output control device distributes the plurality of images to the plurality of image display devices so that each image display device displays at least one image. The output control device controls the at least one sound output device to output the sounds. The plurality of application programs includes a plurality of predetermined audio application programs, each of which provides a sound content. When the output control device executes the plurality of predetermined audio application programs simultaneously, the output control device controls the plurality of image display devices and the at least one sound output device to output the plurality of images and sounds exclusively between the plurality of predetermined audio application programs.

In the above controller, even when the controller controls the image display devices to display multiple images independently at the same time, the controller does not control the sound output device and the image display devices to output multiple images and sounds generated by multiple audio application programs at the same time. Thus, multiple sound sources provided by multiple audio application programs are not introduced into a compartment of the vehicle simultaneously. Therefore, the controller prevents from bothering the user about difficulty of listening to the sounds.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing an image and sound controller;

FIG. 2 is a flowchart showing a switching process of an output when an application program is activated;

FIG. 3 is a flowchart showing a switching process of an output when an application program is terminated;

FIGS. 4A and 4B are diagrams showing a screen image switching process when two images are displayed on two display screens, respectively, according to a normal example;

FIGS. 5A and 5B are diagrams showing a screen image switching process when two images are displayed on two display screens, respectively, according to another normal example;

FIGS. 6A and 6B are diagrams showing a screen image switching process when two images are displayed on two display screens, respectively, according to another normal example;

FIGS. 7A and 7B are diagrams showing a screen image switching process when two images are displayed on two display screens, respectively, according to a failure example;

FIGS. 8A and 8B are diagrams showing a screen image switching process when two images are displayed on two display screens, respectively, according to an improved example;

FIGS. 9A and 9B are diagrams showing a screen image switching process when two images are displayed on two display screens, respectively, according to another failure example; and

FIGS. 10A and 10B are diagrams showing a screen image switching process when two images are displayed on two display screens, respectively, according to another improved example.

### DETAILED DESCRIPTION

An embodiment of the present disclosure will be described with reference to drawings.

(Construction of Image and Sound Controller)

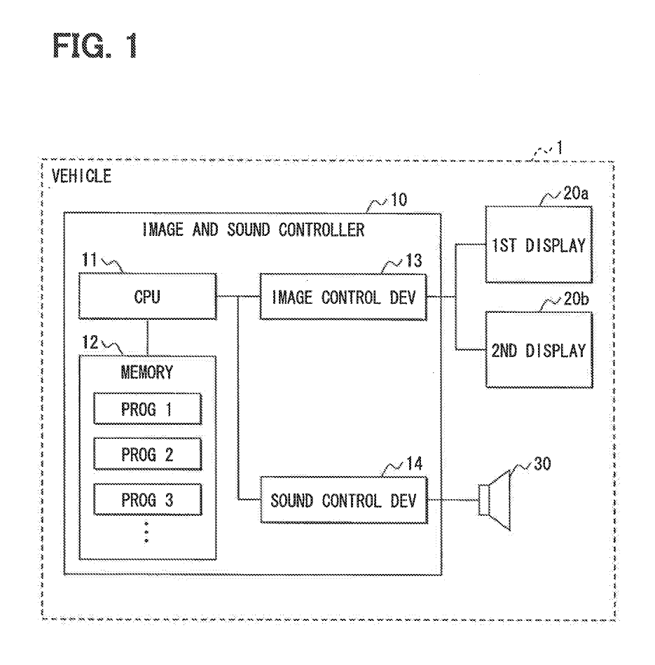

An image and sound controller 10 according to an embodiment is a control apparatus as a central device of an audio visual system mounted on a vehicle 1. For example, the controller 10 is provided by an AV (audio visual) integrated navigation apparatus. As shown in FIG. 1, the controller 10 includes a CPU 11, a memory 12, a display control device 13 and a sound controller 14. Further, two display devices 20a, 20b mounted in a compartment of the vehicle are connected to the display control device 13. When two display devices 20a, 20b are distinguished from each other, one is defined as a first display device 20a, and the other is defined as a second display device 20b. The sound control device 14 is connected to a speaker 30 mounted in the compartment of the vehicle.

The CPU (central processing unit) 11 is a computing processor for controlling each element in the controller 10 according to a program. The CPU 11 executes various application processes based on data and an application program, which are read out from the memory 12. The application process executed by the CPU 11 is, for example, a navigation application process, an audio application process, a television and video application program and a menu application program. A display image and a sound to be generated by these application processes are output from the display devices 20a, 20b and the speaker 30.

The navigation application process provides route guide for a driver of the vehicle. In the navigation application process, a map display process, a route search process, and a route guide process are executed, for example. In the map display process, a map around a current position of the vehicle and a mark indicative of the current position of the vehicle are displayed on a display screen. In the route search process, an optimum route from the current position to a destination is automatically calculated. In the route guide process, a driving way is informed to the driver of the vehicle according to the optimum route obtained in the route search process. The image generated in the navigation application process is displayed on one of the display devices 20a, 20b via the display control device 13. In the route guide process, a guide sound or voice message is output additionally. The guide voice message is output from the speaker 30 via the sound control device 14.

In the audio application process, for example, a sound content (audio content) is output according to a sound source such as a CD drive, a hard disk drive, a digital audio player and a radio tuner. In the audio application process, the sound based on a sound signal from one of the sound sources selected by an user among multiple selectable sound sources is output from the speaker 30 via the sound control device 14. Further, an operation menu screen image for the user to perform various operations such as selection of the sound sources is displayed on one of the display devices 20a, 20b via the display control device 13.

In the television and video application process, a visual content (image content) is output according to a visual source (image and sound source) such as a television tuner, a DVD drive, and a hard disk drive. In the television and video application process, a content image based on an image signal from one of the visual sources selected by the user among multiple selectable visual sources is displayed on one of the display devices 20a, 20b via the display control device 13. An operation menu screen image for the user to perform various operations such as selection of the visual sources is displayed on the other display device 20a, 20b, which is different from the one display device for displaying the content image. The operation menu screen image provides a sub screen image. Further, the sound based on a sound signal from the visual source selected by the user is output from the speaker 30 via the sound control device 14.

In the menu application process, a menu screen image for various operation items is displayed. In the menu application process, a list of the operation items for operating various in-vehicle devices is displayed on one of the display devices 20a, 20b as a menu screen image.

Here, the CPU 11 appropriately determines according to the display contents of the application programs executed at the same time which display device 20a, 20b displays the display contents of the application programs. The procedure for determining in the CPU 11 will be described later.

The audio application program and the television and video application program provide a main function for outputting the sound content as appreciation. Accordingly, these application programs are defined as an audio application programs in the image and sound controller 10. In addition, an application program for providing a hands-free communication function with a cell phone in a compartment of the vehicle is also defined as the audio application program.

The navigation application program and the menu application program do not provide to output the sound content as appreciation only but provide a main function for displaying the visual content. Accordingly, these application programs are defined as a non-audio application programs in the image and sound controller 10.

The memory 12 Includes a hard disk drive, a rewritable nonvolatile semiconductor memory and the like. the memory 12 stores a system program executed by the CPU 11 for operating the image and sound controller 10, application programs, and various data such as image and sound content data. Further, the memory 12 stores the navigation application program, the audio application program, the television and video application program and the menu application program as the application programs.

The display control device 13 distributes and outputs the display image signals generated by multiple application programs, which are executed by the CPU 11, to two display devices 20a, 20b. Thus, the device 13 is an interface unit for outputting an image. The sound control device 14 outputs the sound signal generated by multiple application programs, which are executed by the CPU 11, to the speaker 30. Thus, the device 14 is an interface unit for outputting the sound.

The display device 20a, 20b is a color display apparatus having a display screen such as a liquid display panel. Each display device 20a, 20b is disposed within a range of view of a driver of the vehicle within arm's reach of the driver. Each display device 20a, 20b displays an image as a display image generated by various application programs executed by the CPU 11. The speaker 30 is a sound output apparatus for outputting the sound to the compartment of the vehicle according to a sound generated by various application programs executed by the CPU 11.

(Operation of Image and Sound Controller)

When the application program is activated in the image and sound controller 10, the display image generated by the application program is displayed on at least one of the display devices 20a, 20b. Alternatively, the display image is displayed on both of the display devices 20a, 20b. In the present embodiment, in general, when multiple application programs are activated successively, the images are displayed in order of the first display device 20a, the second display device 20b, the first display device 20a, the second display device 20b, and so on. Thus, the current image generated by the application program, which is currently activated, is displayed on the display screen of one of the display devices 20a, 20b, which has displayed the older image than the other of the display devices 20a, 20b. Thus, the older image of the display devices 20a, 20b is updated to the current image. Further, the sound is switched from the old application program to the current application program in response to the update of the display image. Alternatively, the application programs are preliminary prioritized, and when multiple application programs are activated, one of display images on the display screens, which is generated by the application program having the low priority, is updated to a new image generated by a new application program.

Under the above general procedure, for example, the display image generated by the first audio application program for reproducing the first sound content is displayed on the first display device 20a, and the sound generated based on the first sound content is output from the speaker 30. In this case, when the second application program is activated for reproducing the second sound content, in general, the display image generated by the second audio application program is displayed on the second display device 20b, and the sound generated based on the second sound content is output from the speaker 30 at the same time. However, it may be difficult for the user to distinguish the second sound content from the first sound content since the sounds from the first and second sound contents are mixed. Alternatively, it may be difficult for the user to determine which sound content is reproduced. Thus, the image and sound controller 10 outputs the display image and the sound exclusively among multiple audio application programs.

Under a condition that the application program is activated, when a next application program to be activated is the audio application program, the image and sound controller 10 determines whether the application program, which is activated at the present time, is the audio application program. When the application programs, which are activated at the present time, includes the audio application program, the display image generated by the presently activated audio application program is updated to the display image generated by the newly activated audio application program regardless of the normal order of switching the images and the priority. Further, when the audio content of the prior audio application program is reproduced, the image and sound controller 10 stops outputting the sound generated by the prior audio application program from the speaker 30, and then, the image and sound controller 10 switches to output the audio content of the new audio application program.

Further, one screen of the display device 20a, 20b may be divided into multiple display regions, and each display region displays the display image presented by application program. In this case, the display images of multiple audio application programs are not displayed on one display region, and the sounds presented by multiple audio application programs are not mixed and output from the speaker 30 at the same time. Specifically, when the current image presented by the prior audio application program is displayed and assigned to one display region, which is a part of the display screen, the current image is updated to the image presented by the new audio application program, which is newly activated, so that the new image is displayed on the one display region. When the sound content presented by the prior audio application program is reproduced, the image and sound controller 10 stops reproducing the current sound content, and the controller 10 switches to reproduce the sound content presented by the new audio application program.

(Output Switching Process When Application Program is Activated)

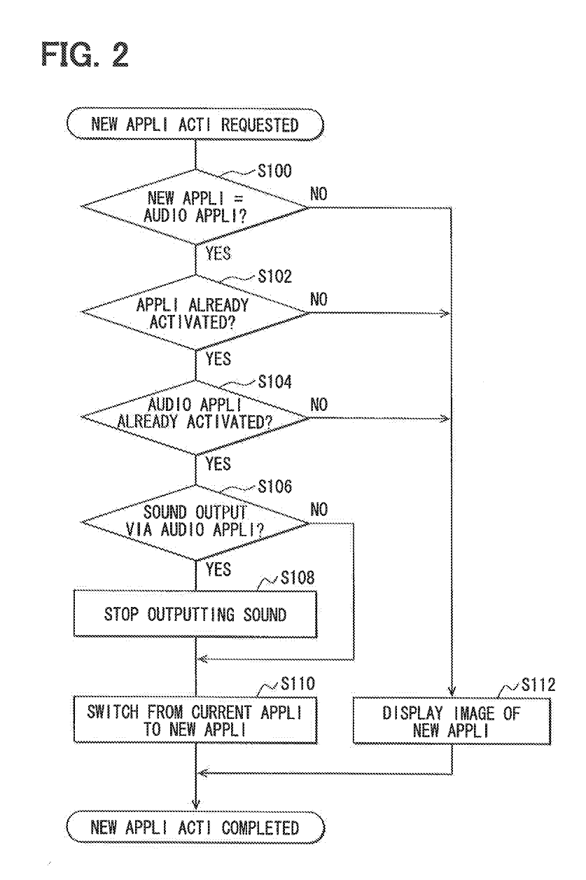

When the CPU 11 of the image and sound controller 10 executes to activate the application program, the procedure of the output switching process is described as follows with reference to FIG. 2. When the controller 10 requires to output the image and sound at the time of activating the application program, the output switching process is executed.

After the activation request of the new application program, at step S100 in FIG. 2, the CPU 11 determines whether the newly activated application program (i.e., the new application program) is the audio application program for outputting the sound content. When the new application program is the audio application program, i.e., when the determination of step S100 is “YES,” it goes to step S102. When the new application program is not the audio application program, i.e., when the determination of step S100 is “NO,” it goes to step S112.

In step S102, the CPU 11 determines whether the application program for outputting the display image and/or the sound is already activated at this moment. When there is the application program other than the new application program, which has been already activated, i.e., when the determination of step S102 is “YES,” it goes to step S104. When there is no application program other than the new application program, which has been already activated, i.e., when the determination of step S102 is “NO,” it goes to step S112.

In step S104, the CPU 11 determines whether there is the audio application program for outputting the sound content among the currently activated application programs, i.e., whether the audio application program has already been activated. When the audio application program exists among the currently activated application programs, i.e., when the determination of step S104 is “YES,” it goes to step S106. When no audio application program exists among the currently activated application programs, i.e., when the determination of step S104 is “NO,” it goes to step S112.

In step S106, the CPU 11 determines whether the sound content is being reproduced and output according to the audio application program, which is currently activated. When the sound content is output through the currently activated audio application program, i.e., when the determination of step S106 is “YES,” it goes to step S108. When the sound content is not output through the currently activated audio application program, i.e., when the determination of step S106 is “NO,” it goes to step S110.

In step S108, the CPU 11 stops outputting the sound content, which is reproduced and output through the currently activated audio application program. In step S110, the CPU 11 controls the display screen of the display device 20a, 20b, which displays the image generated by the currently activated audio application program, to switch the new image generated by the new audio application program. Further, the CPU 11 controls the speaker 30, which outputs the sound generated by the currently activated audio application program, to switch the sound generated by the new audio application program. Here, it may be considered that the currently activated audio application program, which provides the image and the sound to be switched to the new image and sound, is not terminated, but moved to a stand-by mode. When the application program is in the stand-by mode, the display and the speaker do not output the image and the sound. Alternatively, the currently activated audio application program, which provides the image and the sound to be switched to the new image and sound, may be terminated.

When one of the determinations of steps S100, S102 and S104 is “NO,” it goes to step S112. In step S112, the CPU 11 controls a predetermined display device to display the new image generated by the new application program. When the new application program provides the sound, the sound controller 14 controls the speaker 30 to output the sound. Here, in step S112, the predetermined display device for outputting the new image of the new application program is selected from display devices 20a, 20b according to the normal procedure. Specifically, when multiple application programs have been activated at the same time, one of the application programs, which is activated prior to the other of the application programs, is switched to the new application program so that the image of the one of the application programs is updated to the new image generated by the new application program.

When at least one of the display devices does not display anything, the image generated by the new application program may be displayed on the at least one of the display devices. Alternatively, when a certain display device to display the image of the new application program preferentially is preliminary determined, the new application program may be executed to interrupt the certain display device to display the new image of the new application program. In this case, the image of the current application program to be switched to the new image of the new application program may be moved to the other of the display devices. Alternatively, when the new application program provides to require displaying the image on both of the display devices, the current images on both of the display devices 20a, 20b are witched to the new image.

(Output Switching Process When Application Program is Terminated)

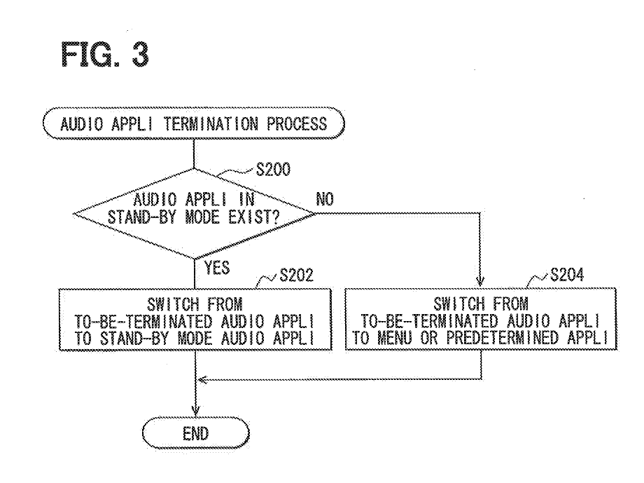

When the CPU 11 of the image and sound controller 10 executes to terminate the application program, the procedure of the output switching process is described as follows with reference to FIG. 3. When the current application program, which has been outputting the image and sound, is terminated, the output switching process is executed.

In step S200, the CPU 11 determines whether there is the audio application program, which is in the stand-by mode, other than the audio application program to be terminated. When the audio application program is terminated, and another audio application program in the stand-by mode exists, i.e., when the determination in step S200 is “YES,” it goes to step S202. In step S202, the CPU 11 controls the display screen to switch from the image generated by the audio application program to be terminated to another image generated by another audio application program in the stand-by mode. Further, the sound controller 14 controls the speaker 30 to switch outputting from the sound generated by the audio application program to be terminated to the sound generated by the audio application program in the stand-by mode.

When the audio application program is terminated, and another audio application program in the stand-by mode does not exist, i.e., when the determination in step S200 is “NO,” it goes to step S204. In step S204, the CPU 11 controls the display device to switch displaying from the image generated by the audio application program to be terminated to the menu image generated by the menu application program or another image generated by a predetermined application program. At this time, the display device displays a predetermined image of a certain application program as a default image.

(Example of Display Image Switching Process)

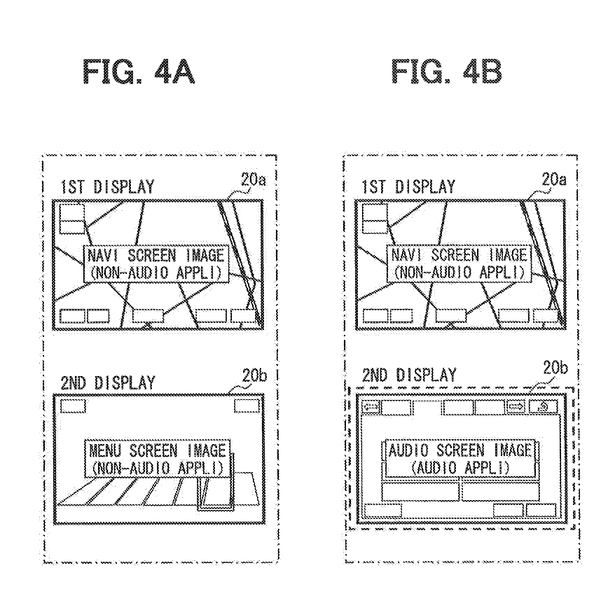

Next, examples of the display image switching process in the image and sound controller 10 will be explained as follows with reference to FIGS. 4 to 10 when two display devices display two images.

(Normal Example No. 1)

Normal example No. 1 represents a case that two display screens display images generated by two different application programs, respectively. FIG. 4A shows a case where two display devices 20a, 20b display two different images, respectively, before switching the images, and FIG. 4B shows a case where two display devices 20a, 20b display two different images, respectively, after switching the images since the audio application program is activated.

In FIG. 4A, the first display device 20a displays the image generated by the non-audio application program such as a navigation application program, and the second display device 20b displays the image generated by the non-audio application program such as a menu application program. Under these situations, the audio application program is newly activated.

In this case, since multiple audio application programs are not activated at the same time, the normal switching process is executed according to the normal condition. FIG. 4B shows the screen images switched from the images in FIG. 4A. Here, only the image on the second display device 20b is switched to the image generated by the newly activated audio application program.

(Normal Example No. 2)

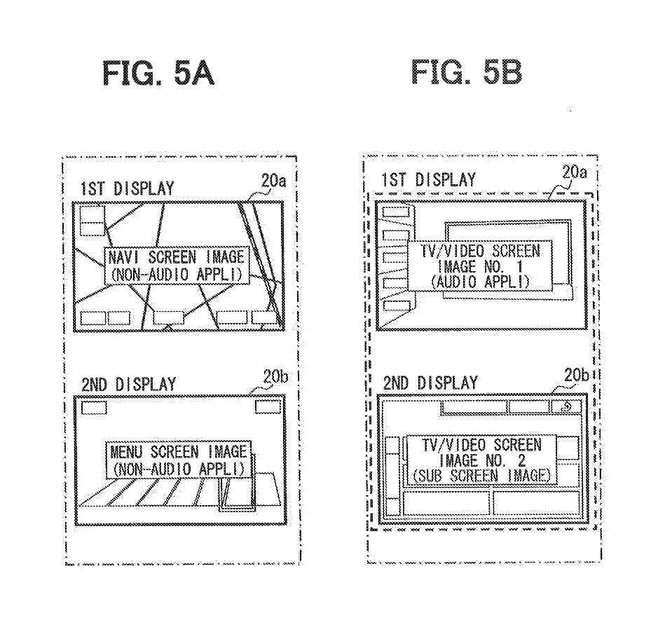

Normal example No. 2 represents a case that two display screens display images generated by the same television and video application program, respectively. FIG. 5A shows a case where two display devices 20a, 20b display two different images, respectively, before switching the images, and FIG. 5B shows a case where two display devices 20a, 20b display two different images generated by the same television and video application program, respectively, after switching the images since the television and video application program is activated. In FIG. 5A, the first display device 20a displays the image generated by the non-audio application program such as a navigation application program, and the second display device 20b displays the image generated by the non-audio application program such as a menu application program. Under these situations, the television and video application program is newly activated. Here, the television and video application program to be newly activated requires to display two different images on two display devices 20a, 20b, respectively.

In this case, both of the display devices 20a, 20b switch the screen images, respectively. FIG. 5B shows the display screens after the images in FIG. 5A are switched when the television and video application program is activated. Here, the display screen of the first display device 20a is switched to the content image generated by the television and video application program, which is newly activated. Further, the display screen of the second display device 20b is switched to an operation menu screen image generated by the television and video application program, which is newly activated.

(Normal Example No. 3)

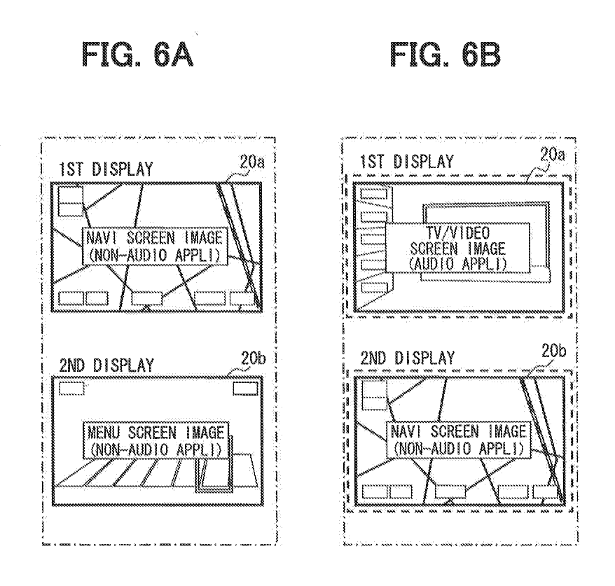

Normal example No. 3 represents a case that the image generated by the television and video application program is preferentially displayed on the first display device 20a. FIG. 6A shows a case where two display devices 20a, 20b display two different images, respectively, before switching the images, and FIG. 6B shows a case where two display devices 20a, 20b display two different images generated by the television and video application program and the navigation application program, respectively, after switching the images since the television and video application program is activated.

In FIG. 6A, the first display device 20a displays the image generated by the non-audio application program such as a navigation application program, and the second display device 20b displays the image generated by the non-audio application program such as a menu application program. Under these situations, the television and video application program as the audio application program is newly activated. Here, the television and video application program to be newly activated requires to display the image on the first display device 20a preferentially, regardless of the activation order of the application programs, which provide to display the images on the display devices 20a, 20b.

In this case, the television and video application program interrupts the first display device 20a to display the image generated by the television and video application program. FIG. 6B shows the display devices 20a, 20b after the images in FIG. 6A are switched when the television and video application program is newly activated. Here, the screen of the first display device 20a is switched to the image generated by the television and video application program, which is newly activated. Further, the screen of the second display device 20b is switched to the image generated by the navigation application program, which was displayed on the first display device 20a.

(Improper Example No. 1)

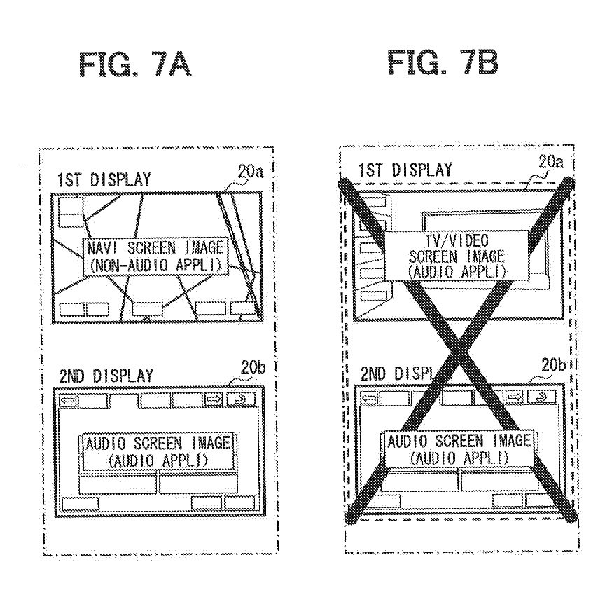

Improper example No. 1 represents a case that the images generated by the audio application program are displayed at the same time. FIG. 7A shows a case where two display devices 20a, 20b display two different images, respectively, before switching the images, and FIG. 7B shows a case where two display devices 20a, 20b display two different images generated by the television and video application program and the audio application program, respectively, after switching the images since the television and video application program is activated.

In FIG. 7A, the first display device 20a displays the image generated by the non-audio application program such as a navigation application program, and the second display device 20b displays the image generated by the audio application program. Under these situations, the television and video application program as the audio application program is newly activated.

In FIG. 7B, the display devices 20a, 20b improperly display the images. Here, the display screen of the first display device 20a is switched to the image generated by the television and video application program, which is newly activated. In this situation, both of the display devices 20a, 20b display the images of two audio application programs, i.e., the television and video application program and the audio application program, at the same time. Normally, only one of the audio application programs is output, so that the images of the audio application programs are not displayed on the display devices 20a, 20b, respectively, at the same time. Accordingly, the image and sound controller 10 does not provide the situation shown in FIG. 7B.

(Improved example No. 1)

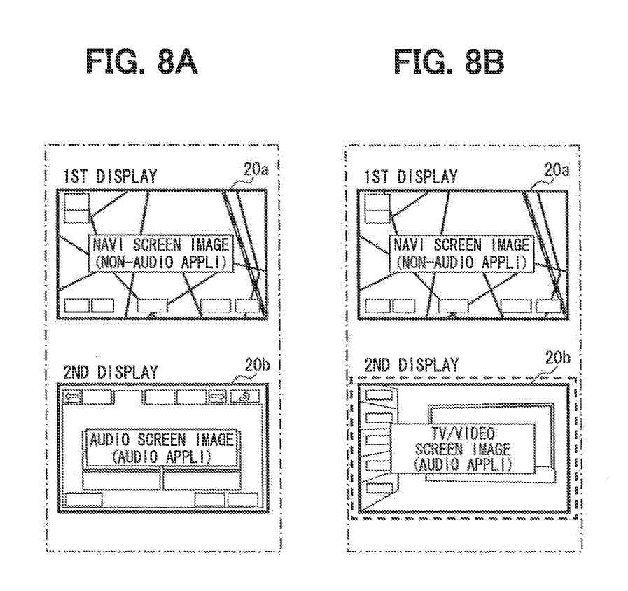

Improved example No. 1 represents a case that only one of the images generated by the audio application programs is displayed at the same time. FIG. 8A shows a case where two display devices 20a, 20b display two different images, respectively, before switching the images, and FIG. 8B shows a case where two display devices 20a, 20b display two different images generated by the navigation application program and the television and video application program, respectively, after switching the images since the television and video application program is newly activated.

In FIG. 8A, the first display device 20a displays the image generated by the non-audio application program such as a navigation application program, and the second display device 20b displays the image generated by the audio application program. Under these situations, the television and video application program as the audio application program is newly activated.

In this case, the outputs generated by multiple audio application programs are exclusively controlled, so that only one of the outputs is permitted to execute. Thus, regardless of the activation order and the priority of the application programs, which has been activated before switching the images, the image generated by the audio application program, which has been activated, is switched to the image generated by the newly activated audio application program. Thus, exclusiveness of the outputs of audio application programs is maintained. FIG. 8B shows an improvement of the improper example in FIG. 7B. FIG. 8B shows the situation after the image in FIG. 8A is switched. Here, the screen of the second display device 20b, which has displayed the image of the audio application program, switches to display the image generated by the newly activated television and video application program.

(Improper Example No. 2)

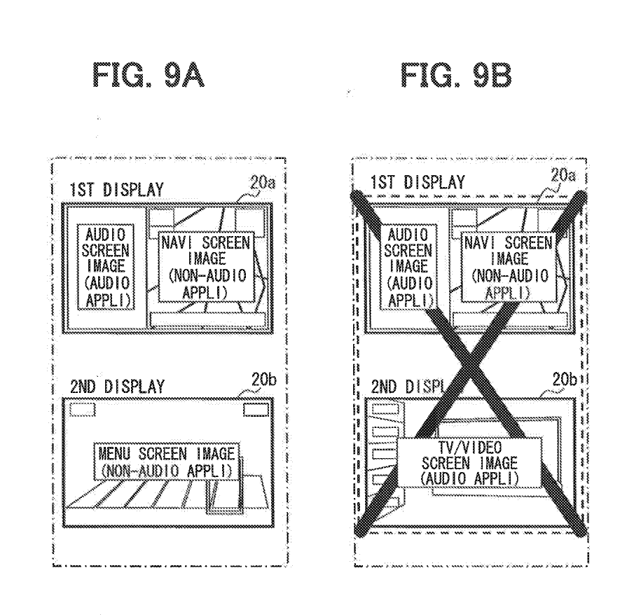

Improper example No. 2 represents a case that the images generated by multiple application programs are displayed on the same display device in a separation layout manner. FIG. 9A shows a case where two display devices 20a, 20b display three different images, respectively, before switching the images, and FIG. 9B shows a case where two display devices 20a, 20b display three different images generated by the audio application program, the navigation application program and the television and video application program and the audio application program, respectively, after switching the images since the television and video application program is activated.

In FIG. 9A, one screen is divided into multiple regions, so that multiple images generated by multiple application programs are displayed in multiple regions, respectively. The image generated by the audio application program is displayed on a left side display region on the screen of the first display device 20a. The image generated by the navigation application program as the non-audio application program is displayed on a right side display region of the first display device 20a. The image of the menu application program as the non-audio application program is displayed on the second display device 20b. Under this situation, the television and video application program as another audio application program is newly activated.

In FIG. 9B, the display devices 20a, 20b improperly display the images. Here, the screen of the second display device 20b is switched from the image in FIG. 9A to the image generated by the newly activated television and video application program. Under this situation, both of the display devices 20a, 20b display two images generated by two audio application programs, i.e., the audio application program and the television and video application program, respectively, at the same time. Normally, only one of the audio application programs is output, so that the images of the audio application programs are not displayed on the display devices 20a, 20b, respectively, at the same time. Accordingly, the image and sound controller 10 does not provide the situation shown in FIG. 9B.

(Improved Example No. 2)

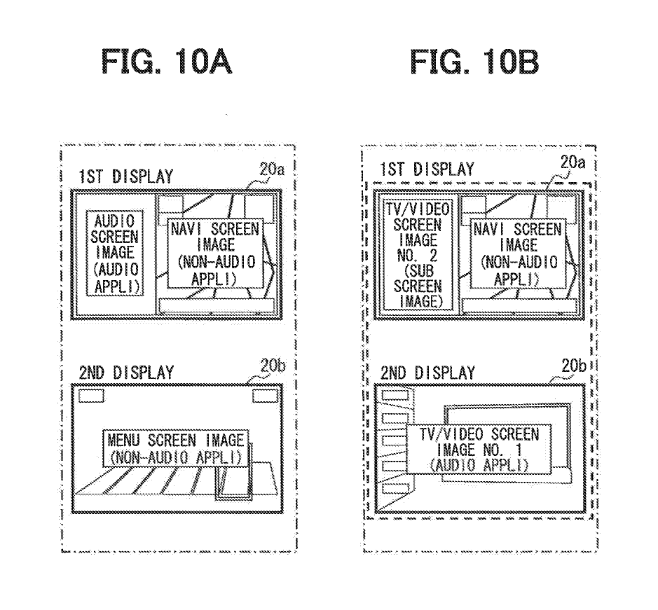

Improved example No. 2 represents a case that only one of the images generated by the audio application programs is displayed at the same time. FIG. 10A shows a case where two display devices 20a, 20b display three different images, respectively, before switching the images, and FIG. 10B shows a case where two display devices 20a, 20b display thee different images generated by the navigation application program and the television and video application program, respectively, after switching the images since the television and video application program is newly activated.

In FIG. 10A, the screen is divided into multiple display regions, so that multiple images generated by multiple application programs are displayed on multiple display regions, respectively. The image generated by the audio application program is displayed on a left side display region on the screen of the first display device 20a. The image generated by the navigation application program as the non-audio application program is displayed on a right side display region of the first display device 20a. The image of the menu application program as the non-audio application program is displayed on the second display device 20b. Under this situation, the television and video application program as another audio application program is newly activated. Here, the newly activated television and video application program requires to display two different images on two screens, respectively.

In this case, the outputs generated by multiple audio application programs are exclusively controlled, so that only one of the outputs is permitted to execute. Thus, regardless of the activation order and the priority of the application programs, which has been activated before switching the images, the image generated by the audio application program, which has been activated, is switched to the image generated by the newly activated audio application program. Thus, exclusiveness of the outputs of audio application programs is maintained. FIG. 10B shows an improvement of the improper example in FIG. 9B. FIG. 10B shows the situation after the image in FIG. 10A is switched. Here, the left side display region of the screen of the second display device 20a, which has displayed the image of the audio application program, switches to display the operation menu image generated by the newly activated television and video application program. Further, the screen of the second display device 20b is switched to the content image of the television and video application program, which is newly activated.

(Effects)

The image and sound controller 10 has the following effects. In a system for displaying multiple images generated by multiple application programs on multiple display devices independently, the image and the sound among multiple audio application programs are exclusively output. Thus, the sound sources from multiple audio application programs are not output and mixed in the compartment of the vehicle at the same time. Thus, the user can easily listen to the sound. Specifically, the controller 10 prevents from bothering the user about difficulty of listening.

When the image and sound are exclusively switched between multiple audio application programs, the current audio application program, which is to be excluded, may be put into the standby mode with activating the excluded audio application program. In this case, when a certain audio application program is terminated, the image and sound generated by the excluded audio application program in the stand-by mode are recovered rapidly, instead of the image and sound of the certain audio application program.

In the above embodiment, the controller 10 controls two display devices 20a, 20b. Alternatively, the controller 10 may control three or more display devices, which are mounted on the vehicle.

The CPU 11 provides an image control device or an output control device. The display device 20a, 20b provides an image displaying device. The speaker 30 provides a sound output device.

The above disclosure has the following aspects.

According to an example aspect of the present disclosure, an image and sound controller for a vehicle includes: an output control device for controlling a plurality of image display devices and at least one sound output device, which are mounted on the vehicle. The output control device executes a plurality of application programs simultaneously so that a plurality of images and sounds are provided by the plurality of application programs. The output control device distributes the plurality of images to the plurality of image display devices so that each image display device displays at least one image. The output control device controls the at least one sound output device to output the sounds. The plurality of application programs includes a plurality of predetermined audio application programs, each of which provides a sound content. When the output control device executes the plurality of predetermined audio application programs simultaneously, the output control device controls the plurality of image display devices and the at least one sound output device to output the plurality of images and sounds exclusively between the plurality of predetermined audio application programs.

Here, the audio application program provides a main function for outputting a sound content for a user. Further, the audio application program provides another function for outputting an image such as a motion picture and a menu screen image.

In the above controller, even when the controller controls the image display devices to display multiple images independently at the same time, the controller does not control the sound output device and the image display devices to output multiple images and sounds generated by multiple audio application programs at the same time. Thus, multiple sound sources provided by multiple audio application programs are not introduced into a compartment of the vehicle simultaneously. Therefore, the controller prevents from bothering the user about difficulty of listening to the sounds. In the above controller, although the images and sounds generated by multiple audio application programs are exclusively output, the images and sounds generated by multiple non-audio application programs are not output exclusively. Further, the images and sounds generated by an audio application program and a non-audio application program are not output exclusively.

Alternatively, the plurality of predetermined audio application programs may include an audio application program, a television and video application program, and an application program for providing a hands free communication function together with a cell phone. Further, when the output control device executes the plurality of predetermined audio application programs simultaneously, the output control device may control the plurality of image display devices and the at least one sound output device to output at least one image and sound, which is provided by only one predetermined audio application program.

Alternatively, the plurality of predetermined audio application programs may includes a first audio application program and a second audio application program. When the output control device controls the plurality of image display devices and the at least one sound output device to output at least one image and sound, which is provided by the first audio application program, and the second audio application program is newly activated so as to output another image and sound, the output control device controls the plurality of image display devices and the at least one sound output device to switch from the at least one image and sound to the another image and sound. In this case, the images and sounds are always switched to a new audio application program.

Alternatively, when the output control device controls the plurality of image display devices and the at least one sound output device to switch the plurality of images and sounds exclusively between the plurality of predetermined audio application programs, the output control device may put an excluded predetermined audio application program into a stand-by mode. In this case, even when the image display devices and the sound output device interrupt to output the images and sound generated by the excluded predetermined audio application program, the controller maintains the stand-by mode of the excluded predetermined audio application program. Thus, if necessary, the images and sound generated by the excluded predetermined audio application program are rapidly recovered.

Further, when the output control device terminates to execute one predetermined audio application program, which provides to output at least one image and sound, and there is the excluded predetermined audio application program in the stand-by mode, the output control device may controls the plurality of image display devices and the at least one sound output device to switch from the at least one image and sound generated by the one predetermined audio application program to at least one image and sound generated by the excluded predetermined audio application program. In this case, the images and sound generated by the excluded predetermined audio application program are rapidly recovered.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An image and sound controller for a vehicle comprising:
an output control device for controlling a plurality of image display devices and at least one sound output device, which are mounted on the vehicle,
wherein the output control device executes a plurality of application programs simultaneously so that a plurality of images and sounds are provided by the plurality of application programs,
wherein the output control device distributes the plurality of images to the plurality of image display devices so that each image display device displays at least one image,
wherein the output control device controls the at least one sound output device to output the sounds,
wherein the plurality of application programs includes a plurality of predetermined audio application programs, each of which provides a sound content, and
wherein, when the output control device executes the plurality of predetermined audio application programs simultaneously, the output control device controls the plurality of image display devices and the at least one sound output device to output the plurality of images and sounds exclusively between the plurality of predetermined audio application programs.

2. The image and sound controller according to claim 1,
wherein the plurality of predetermined audio application programs include an audio application program, a television and video application program, and an application program for providing a hands free communication function together with a cell phone.

3. The image and sound controller according to claim 1,
wherein, when the output control device executes the plurality of predetermined audio application programs simultaneously, the output control device controls the plurality of image display devices and the at least one sound output device to output at least one image and sound, which is provided by only one predetermined audio application program.

4. The image and sound controller according to claim 1,
wherein the plurality of predetermined audio application programs includes a first audio application program and a second audio application program, and
wherein, when the output control device controls the plurality of image display devices and the at least one sound output device to output at least one image and sound, which is provided by the first audio application program, and the second audio application program is newly activated so as to output another image and sound, the output control device controls the plurality of image display devices and the at least one sound output device to switch from the at least one image and sound to the another image and sound.

5. The image and sound controller according to claim 1,
wherein, when the output control device controls the plurality of image display devices and the at least one sound output device to switch the plurality of images and sounds exclusively between the plurality of predetermined audio application programs, the output control device puts an excluded predetermined audio application program into a stand-by mode.

6. The image and sound controller according to claim 5,
wherein, when the output control device terminates to execute one predetermined audio application program, which provides to output at least one image and sound, and there is the excluded predetermined audio application program in the stand-by mode, the output control device controls the plurality of image display devices and the at least one sound output device to switch from the at least one image and sound generated by the one predetermined audio application program to at least one image and sound generated by the excluded predetermined audio application program.
